(19) United States
(12) Patent Application Publication
(10) Pub. No.: US 2011/0147472 A1
(43) Pub. Date: Jun. 23, 2011

(54) REMOVABLE MEDIUM AND MEDIUM MANAGEMENT DEVICE

(75) Inventors: Akihiro WATABE, Nara (JP); Ryuichiro Tanaka, Kyoto (JP); Masahiro Tani, Osaka (JP)

(73) Assignee: PANASONIC CORPORATION, Osaka (JP)

(21) Appl. No.: 13/037,994

(22) Filed: Mar. 1, 2011

Related U.S. Application Data
(63) Continuation-in-part of application No. PCT/JP2009/001504, filed on Mar. 31, 2009.

(30) Foreign Application Priority Data
Sep. 3, 2008 (JP) 2008-226228

(51) Int. Cl. G06K 19/06

(52) U.S. Cl. 235/494

(57) ABSTRACT

A removable medium includes a data separator configured to separate data input from a digital camera which is an external apparatus into storage data and display data, a data storage configured to store the storage data as a content, and a medium information display configured to display the display data as an image. The medium information display includes, for example, electronic paper in order to, even after the removable medium is removed from the digital camera, continue to display an image as it was displayed immediately before the removal of the removable medium. The removable medium further has a function of outputting the display data of the medium information display to the outside.

### CROSS-REFERENCE TO RELATED APPLICATIONS

This is a continuation of PCT International Application PCT/JP2009/001504 filed on Mar. 31, 2009, which claims priority to Japanese Patent Application No. 2008-226228 filed on Sep. 3, 2008. The disclosures of these applications including the specifications, the drawings, and the claims are hereby incorporated by reference in their entirety.

### BACKGROUND

The present disclosure relates to removable storage media, and more particularly, to techniques of managing contents stored in a large number of removable media.

In recent years, there has been an increasing demand for removable media for use in computers and digital consumer electronics. For example, for computers, floppy disks (FDs), which were previously popular, and in addition, CDs, DVDs, USB memories, removable hard disks, etc. are available. For VTRs, which are a type of consumer electronics, videotapes are used to store video data. For digital cameras, SD memory cards are mostly used to store captured image data. Thus, there are known removable media in the form of a disk or a tape, and removable media employing a semiconductor memory.

When an FD is inserted into a disk drive of a computer, contents stored on the FD can be displayed on a monitor screen of the computer. Note that if a user possesses a large number of FDs, it may be time consuming and tedious for the user to find an FD storing desired contents using this method.

Therefore, labels may be attached to FDs to manage stored contents as in the case of videotapes. This is a conventional and popular management technique. However, the user must spend time and effort to prepare labels. Moreover, when contents are rewritten, it may be necessary to remove an old label and attach a new label.

On the other hand, there is a known technique of automatically assigning identification numbers to FDs by utilizing a rewritable printing system which is applied to, for example, a rewritable loyalty card. The use of this technique can simplify label replacement to some extent (see Japanese Patent Publication No. 2000-260161).

### SUMMARY

In the above conventional technique employing the rewritable printing system, special hardware for the rewritable printing system needs to be added to an external apparatus for writing data onto removable media, leading to an increase in cost.

The present disclosure describes implementations of a technique of easily identifying contents stored in removable media, thereby efficiently managing the contents.

According to the present disclosure, in a removable medium having an electrical interface, such as a removable medium including a semiconductor storage, a removable hard disk, etc., electronic labeling is achieved by using the interface.

An example removable medium of the present disclosure includes a data separator configured to separate data input from an external apparatus into storage data and display data, a data storage configured to store the storage data as a content, and a medium information display configured to display the display data as an image. The medium information display is configured to, even after the removable medium is removed from the external apparatus, continue to display an image as it was displayed immediately before the removal of the removable medium. The removable medium further has a function of outputting the display data of the medium information display to the outside. With this configuration, a label equivalent (electronic label) representing a recorded content can be easily created without adding any special hardware to the external apparatus. Moreover, the removable medium has a function of outputting the display data of the medium information display to the outside.

An example medium management device of the present disclosure includes a medium determiner configured to determine whether or not display data is stored in a removable medium, a display data reader configured to read the display data when the medium determiner determines that the display data is stored in the removable medium, a content reader configured to read a content stored in the removable medium, and a management information display configured to display the content and the display data in association with each other, thereby increasing the convenience of medium management.

The removable medium of the present disclosure maintains the display of information about the removable medium even after the removable medium is removed from an external apparatus, thereby indicating its contents by itself. Therefore, the user can easily confirm the recorded contents of the removable medium. In addition, labeling can be achieved by using an electrical interface, whereby the contents of a plurality of removable media can be easily managed without an increase in cost of an external apparatus for writing data into the removable media. Moreover, optimum labeling can be easily achieved by changing the software of the external apparatus.

The medium management device of the present disclosure can provide, to the user, intuitive representation of correspondences between contents of a plurality of removable media each having a medium information display and the removable media themselves, and therefore, is useful for management of the contents of removable media.

### BRIEF DESCRIPTION OF THE DRAWINGS

FIG. 1 is block diagram showing an example configuration of a removable medium according to an embodiment of the present disclosure, along with a digital camera as an external apparatus.

FIG. 2 is a diagram showing an example image displayed on a medium information display of FIG. 1.

FIG. 3 is a block diagram showing an example internal configuration of a display controller of FIG. 1.

FIG. 4 is a flowchart of a medium initialization process performed by the digital camera of FIG. 1.

FIG. 5 is a block diagram showing an example configuration of a medium management device according to an embodiment of the present disclosure.

FIG. 6 is a diagram showing an example image displayed on a management information display of FIG. 5.

FIG. 7 is a flowchart showing operation of the medium management device of FIG. 5.

FIG. 8 is a diagram showing an example configuration of a medium management device according to another embodiment of the present disclosure.

FIG. 9 is a diagram showing an example image displayed on a main display of FIG. 8.

FIG. 10 is a diagram showing an example image displayed on one of a plurality of individual medium displays of FIG. 8.

### DETAILED DESCRIPTION

Embodiments of the present disclosure will be described hereinafter with reference to the accompanying drawings.

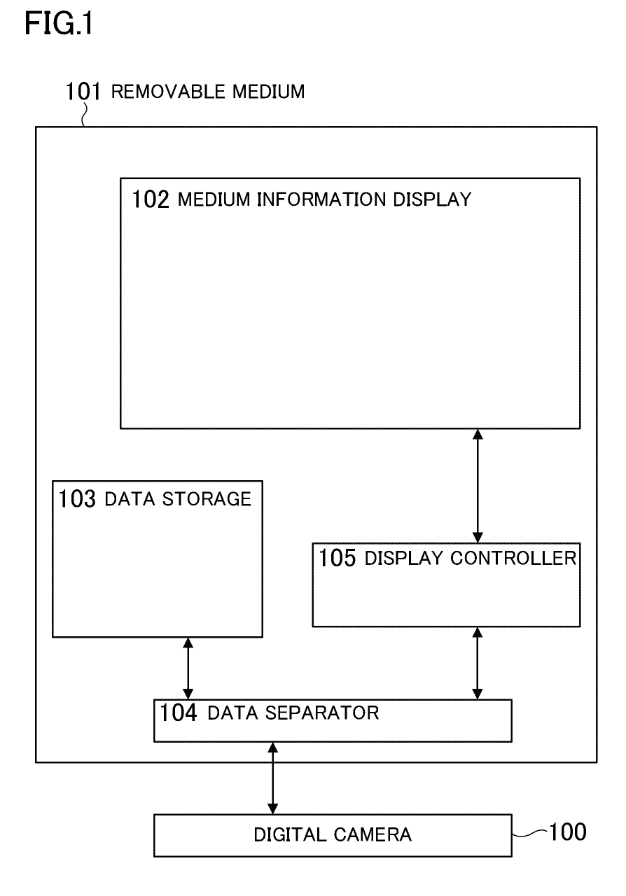

FIG. 1 shows an example configuration of a removable medium according to an embodiment of the present disclosure, along with a digital camera as an external apparatus. The removable medium 101 of FIG. 1 is used in, for example, the digital camera 100. The removable medium 101 includes a data separator 104 which separates data input from the digital camera 100 into data to be stored (storage data) and data to be displayed (display data), a data storage 103 which stores the storage data as a content, a medium information display 102 which displays the display data as an image, and a display controller 105 which controls operation of the medium information display 102.

The digital camera 100 which is an external apparatus which uses the removable medium 101, can access the data storage 103 and the display controller 105 via the data separator 104 to store or save desired data or control the medium information display 102. The data storage 103 is a non-volatile storage which can retain data even when not powered.

The medium information display 102 may be, for example, electronic paper which, even after the removable medium 101 is removed from the digital camera 100, continues to display an image as it was displayed immediately before the removal of the removable medium 101. Electronic paper requires power only when the display is updated. Technologies applied to electronic paper include liquid crystal displays, electronic liquid powder displays, etc. Note that the medium information display 102 is not limited to electronic paper. For example, the medium information display 102 may include a small battery for providing backup power, thereby holding images with low power.

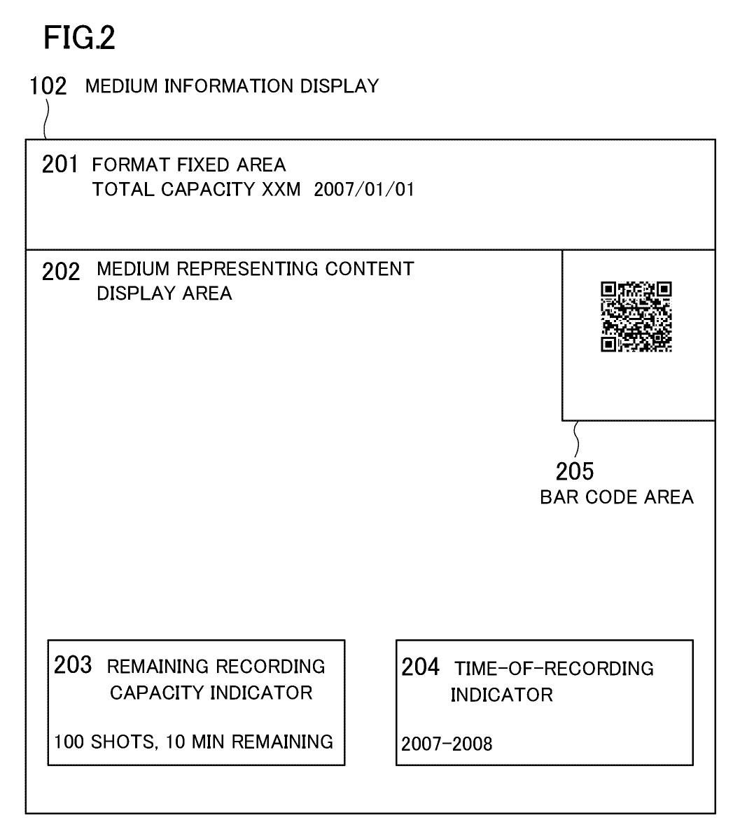

FIG. 2 shows an example image displayed on the medium information display 102 of FIG. 1. The displayed image has a format fixed area 201, a medium representing content display area 202, a remaining storage capacity indicator 203, a time-of-recording indicator 204, and a barcode area 205.

The format fixed area 201 is an area in which information about the total capacity, the date of formatting, etc. is written during initialization. The format fixed area 201 is not subsequently updated even when data is written into the removable medium 101, unlike the other areas 202-205. In the format fixed area 201, a format type or a feature of a formatting apparatus may also be written. For example, when the name of a digital camera is written, the user will understand that the removable medium 101 is appropriate to the specific digital camera.

In the medium representing content display area 202, a copy of image data appropriately selected from the contents of the data storage 103 is written as a label. An illustration associated with the contents may be written. Alternatively, a simple illustration for identifying the removable medium 101 may be written, regardless of the contents.

The remaining storage capacity indicator 203 is an area in which the remaining storage capacity of the data storage 103 is displayed. Although the remaining storage capacity represented by the number of bytes may be displayed, it is more convenient for the user to display the number of remaining shots for still images and the remaining recordable time for movies. The time-of-recording indicator 204 is an area in which the time of recording of the data storage 103 is displayed. For example, if there is information indicating that images were taken in the previous year, the user may guess what contents are stored to some extent. Note that the display of the remaining storage capacity and the time of recording is updated every time data is added to or erased from the data storage 103.

In the barcode area 205, a two-dimensional bar code is displayed which is obtained by converting the remaining storage capacity, the time of recording, title information, etc. every time those pieces of information are updated. Therefore, the bar code area 205 can be used to easily send the information to an apparatus which can read the two-dimensional bar code, such as a mobile telephone etc. Here, although an external apparatus for reading a bar code is required, the removable medium 101 does not need to be inserted into the external apparatus, but the required information can be sent by only scanning the bar code. Therefore, a large number of removable media can be efficiently identified. In particular, when the removable medium 101 is one which is of a very small size, such as a micro SD card etc., it is preferable to mainly use such a bar code to manage the removable medium 101.

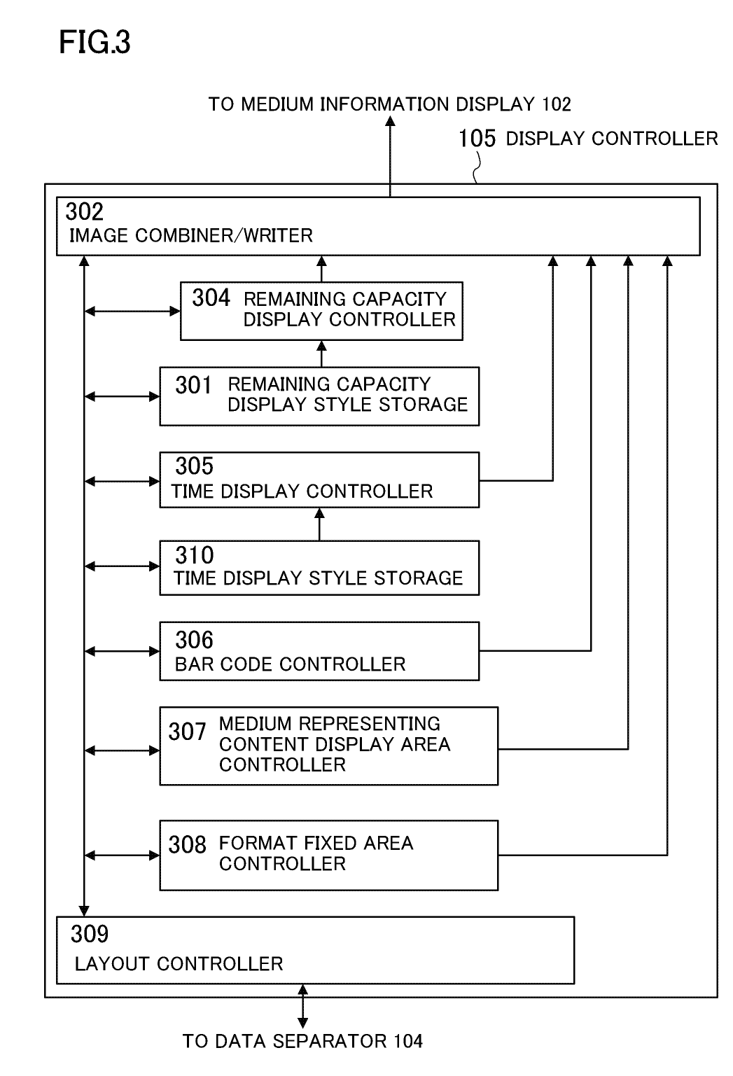

FIG. 3 shows an example internal configuration of the display controller 105 of FIG. 1. In order to generate the display screen shown in FIG. 2, the display controller 105 includes storages and controllers corresponding to the respective display areas. Information about the resolution of each display area and information about the arrangement of the display areas can be read by an external apparatus. Specifically, a remaining capacity display controller 304, the time display controller 305, a bar code controller 306, a medium representing content display area controller 307, and a format fixed area controller 308 generate respective corresponding images, which are then combined into a single image by an image combiner/writer 302, and the resultant image is then displayed.

The display controller 105 also includes a remaining capacity display style storage 301. The remaining capacity display controller 304 generates an image indicating the remaining storage capacity based on the stored style. The display controller 105 also includes a time display style storage 310. The time display controller 305 generates an image indicating the time of recording based on any of the following display styles: in year, month, day order; in day, month, year order; etc. Assuming that the removable medium 101 is used worldwide or there are a plurality of display styles even in a single country, it is preferable that the removable medium 101 itself should store the time display styles.

The layout of the areas on the screen is controlled by a layout controller 309. For example, the display position of each area may be changed, or the display of the bar code may be canceled. The layout controller 309 can output information about the allocated size of each area etc. to the outside, so that the digital camera 100 can change image types, depending on the area size.

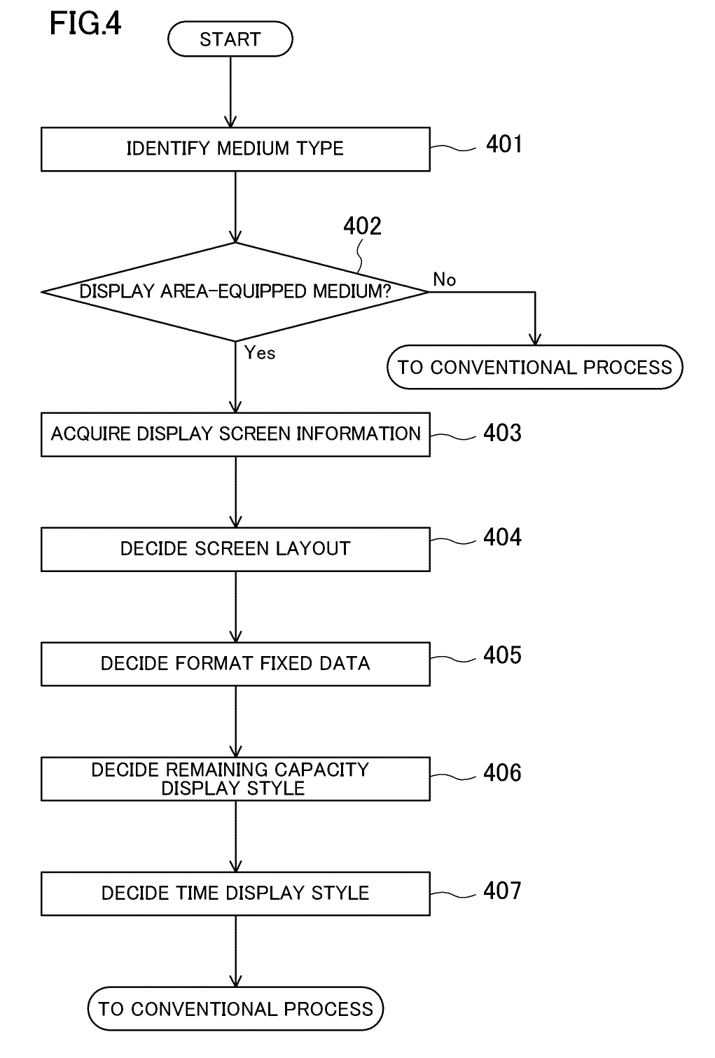

FIG. 4 is a flowchart of a medium initialization process performed by the digital camera 100 of FIG. 1. When the removable medium 101 is connected to the digital camera 100 for the first time, the removable medium 101 is initialized.

Initially, in step 401, the type of the medium 101 is determined. In step 402, it is checked whether or not the medium 101 is a display area-equipped medium, i.e., the aforementioned removable medium which has the medium information display 102. Here, when the medium 101 is not a display area-equipped medium, a conventional operation is performed. When the medium 101 is a display area-equipped medium, information about the resolution etc. of the display area is obtained in step 403 in order to generate appropriate data based on the resolution.

Next, in step 404, a screen layout is decided. In step 405, format fixed data is decided. In step 406, a remaining capacity display style is decided. In step 407, a time display style is decided. In step 404, it is decided how the display screen is divided into display areas, such as those shown in FIG. 2 (screen layout deciding step). Note that the order of these steps is not essential, and the steps may be performed in any order.

The formatting process is thus completed. Thereafter, an appropriate image can be provided for each display area. As a result, an appropriate label is automatically attached to the removable medium 101.

For example, SD memory cards are small, and their display areas are so limited that the amount of information which can be displayed is small. Therefore, a distinguishable illustration etc. for identifying the removable medium 101 may be drawn in the medium information display 102, and the removable medium 101 may be actually managed by using another apparatus.

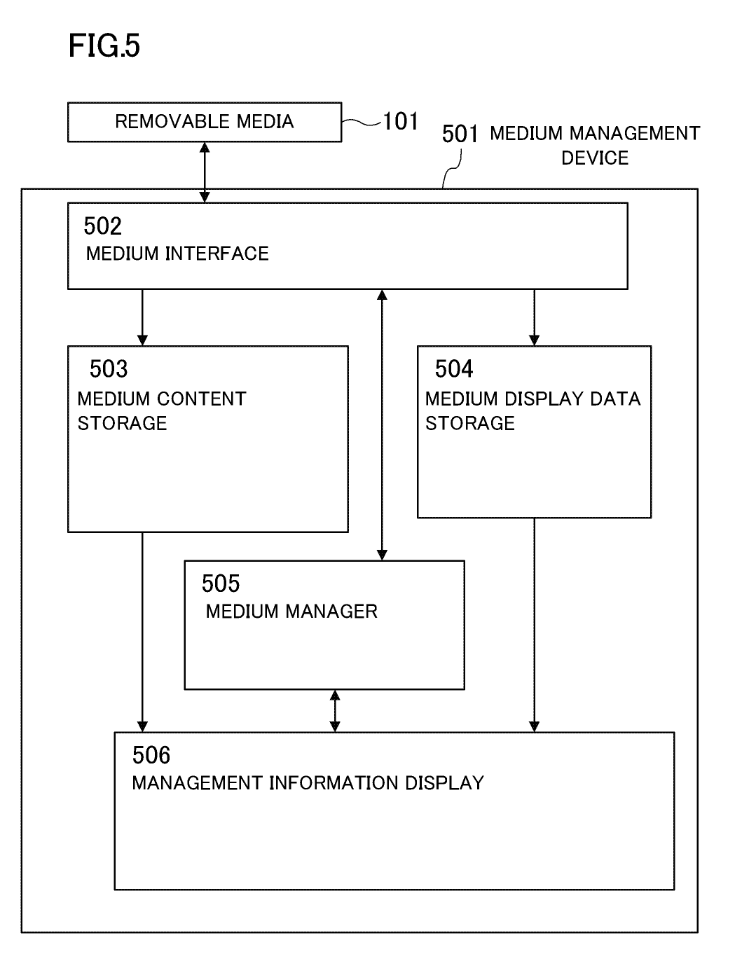

FIG. 5 shows an example configuration of a medium management device according to an embodiment of the present disclosure. The medium management device 501 of FIG. 5 includes a medium interface 502, a medium content storage 503, a medium display data storage 504, a medium manager 505, and a management information display 506. Removable media 101 have a function of outputting display data of the medium information display 102 to the outside. The medium management device 501 reads contents and display data from the removable media 101 and stores the contents and the display data in association with each other.

The management information display 506 displays the contents of an individual removable medium on a large screen, and at the same time, can display the corresponding medium display data. The contents and the medium display data can be arbitrarily selected from those of a large number of removable media 101 which are managed by the medium management device 501.

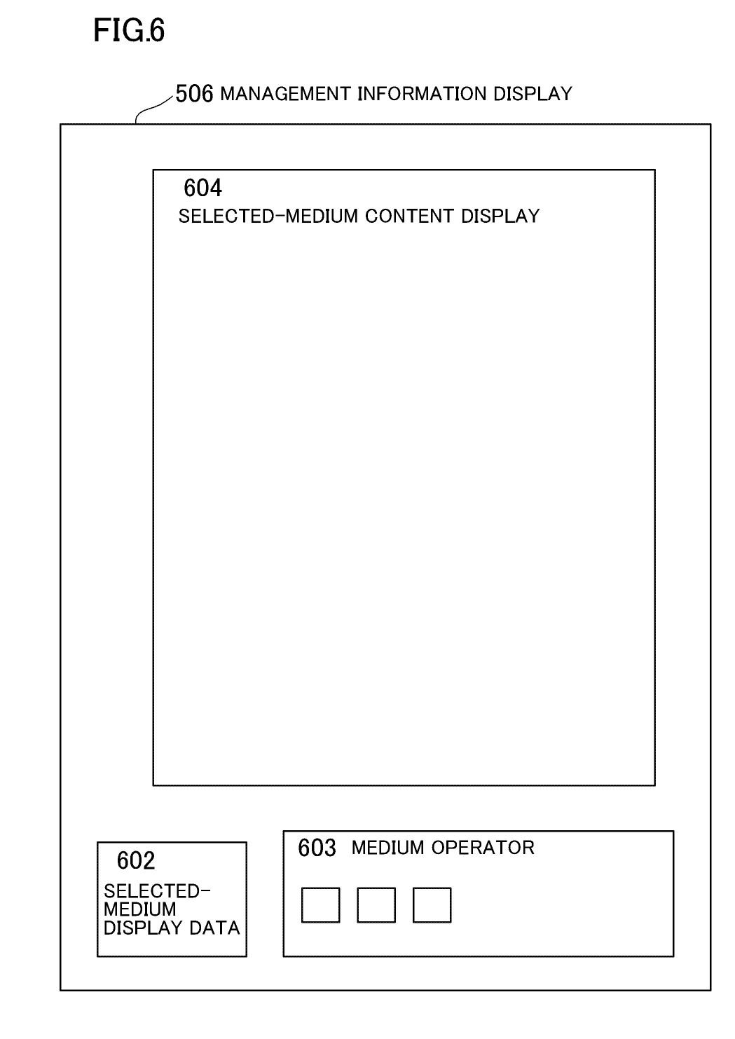

FIG. 6 shows an example displayed image on the management information display 506 of FIG. 5. Information about contents stored in the currently selected medium is displayed on a selected-medium content display 604. Image data of the medium information display 102 provided in the currently selected medium is displayed as selected-medium display data 602. A medium operator 603 is a screen on which the user selects one of the removable media 101 managed by the medium management device 501. In the medium operator 603, icons (images) of the medium information displays 102 of the removable media 101 are arranged so that the user can easily select a desired removable medium.

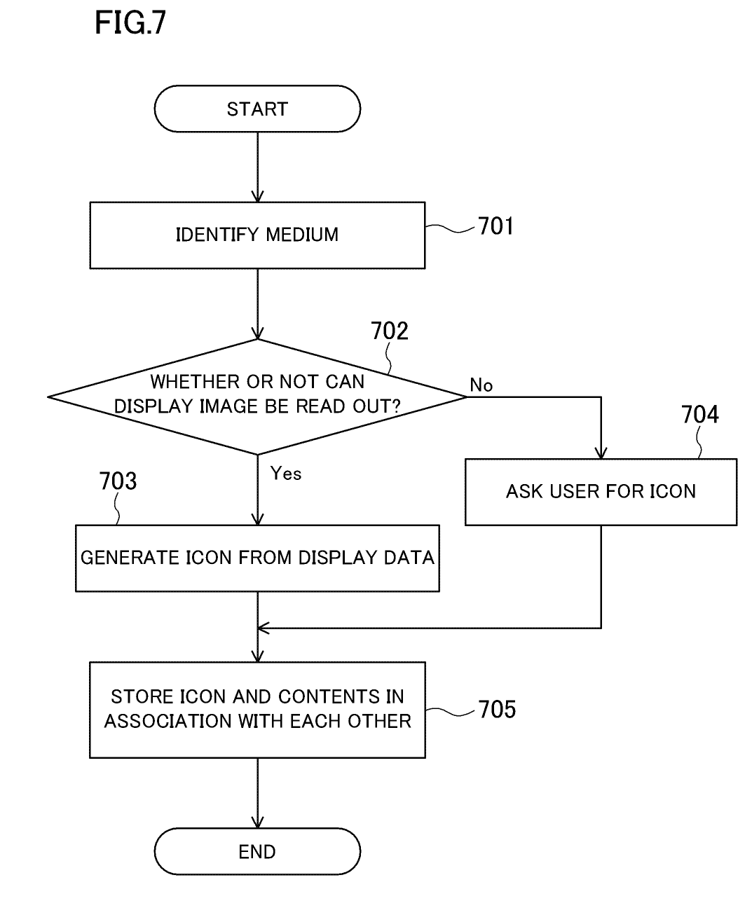

FIG. 7 shows operation which is performed when a removable medium is inserted into the medium management device 501 of FIG. 5. In step 701, the type of the removable medium is determined. In step 702, it is checked whether or not a medium display image can be read out, i.e., whether or not display data is available. When display data is available, an icon is generated in step 703. When display data is not available, an alternative icon is generated by, for example, asking the user in step 704. Finally, in step 705, the generated icon and the contents of the medium are stored in association with each other. By these steps, a correspondence between the removable medium and the contents of the removable medium is stored into the medium management device 501.

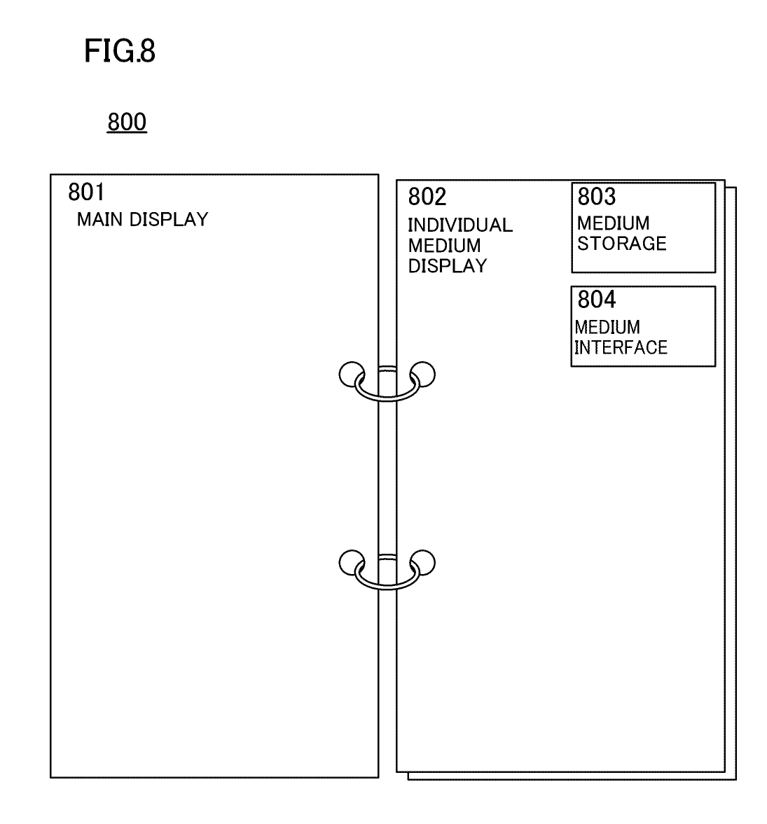

FIG. 8 shows an example configuration of a medium management device according to another embodiment of the present disclosure. The medium management device 800 of FIG. 8 is significantly different from the medium management device 501 of FIG. 5 in that the medium management device 800 includes a plurality of display screens and a plurality of medium slots, and can manage a plurality of removable media 101 in an album-like manner. Specifically, the medium management device 800 includes a main display 801 and a plurality of individual medium displays 802. These displays are fastened together at edges thereof like a book, and can be turned like pages.

The individual medium displays 802 each include a medium storage (or holder) 803. A removable medium is inserted and stored (or held) in the medium storage 803. The individual medium displays 802 each also include a medium interface 804 which is used to read the contents of the inserted removable medium.

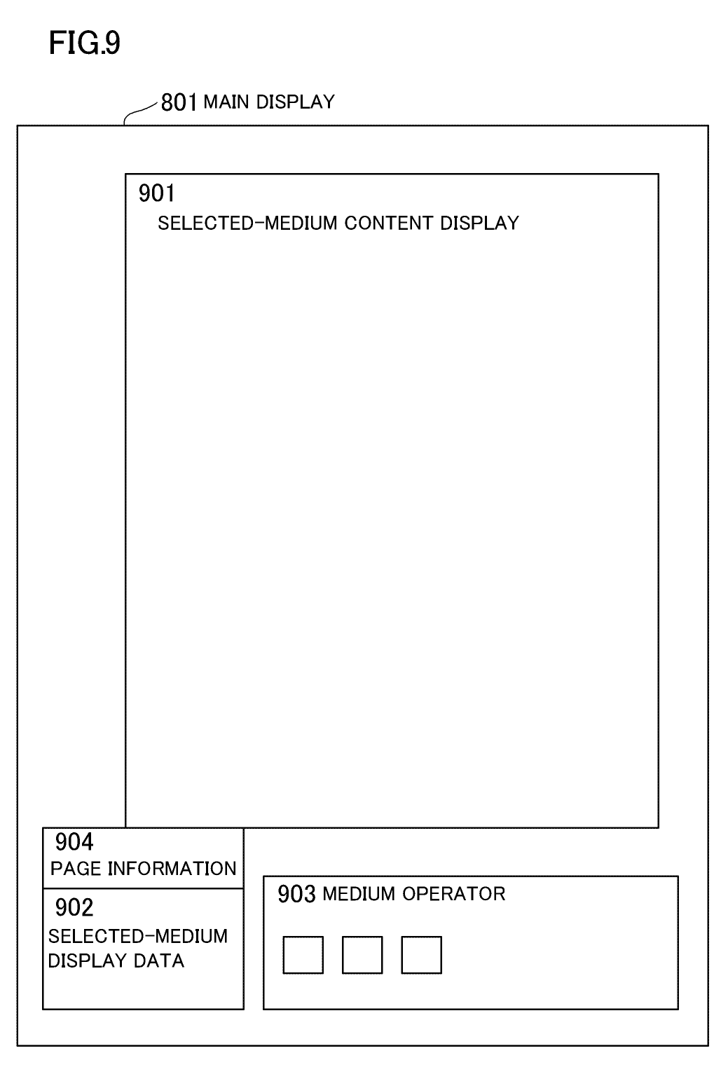

FIG. 9 shows an example image displayed on the main display 801 of FIG. 8. In FIG. 9, a reference numeral 901 indicates a selected-medium content display, a reference numeral 902 indicates selected-medium display data, and a reference numeral 903 indicates a medium operator. The displayed image of FIG. 9 is almost similar to that of FIG. 6, except for page information 904. The page information 904 indicates which of the individual medium displays 802 stores the selected removable medium in its medium storage 803, specifically, what page (individual medium display) number the selected removable medium is on. If the selected removable medium is not stored in any of the individual medium displays 802, the page information 904 is not displayed.

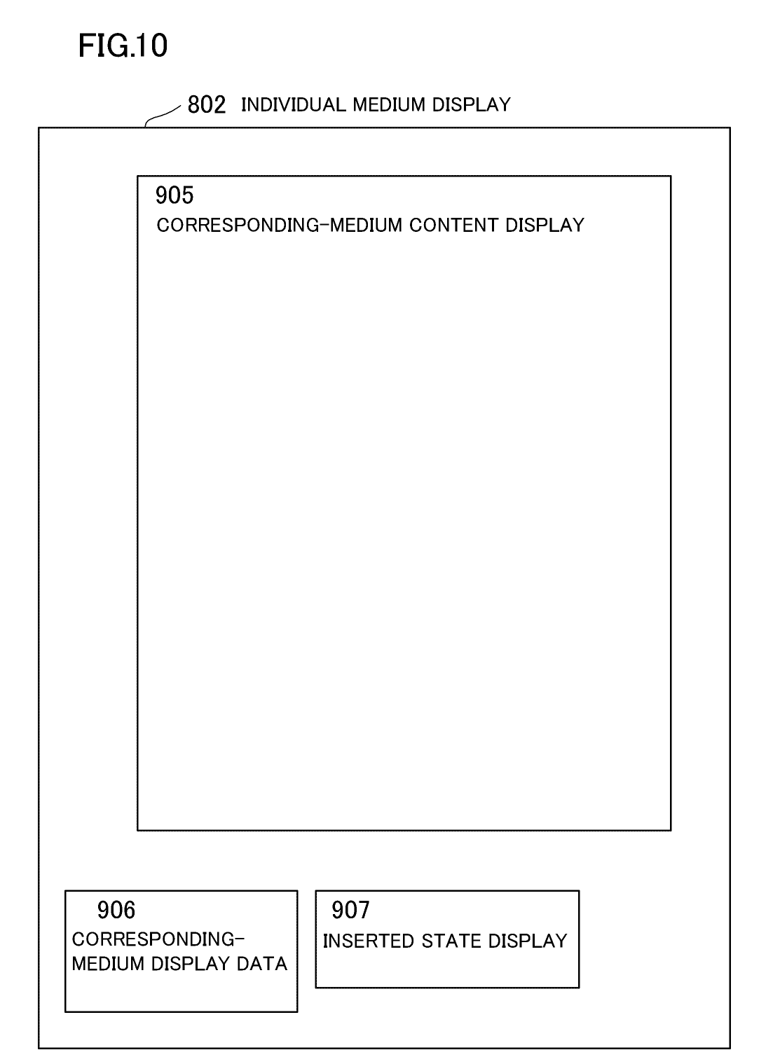

FIG. 10 shows an example displayed image in one of the individual medium displays 802 of FIG. 8. The individual medium display 802 of FIG. 10 includes a corresponding-medium content display 905 which displays contents of a corresponding removable medium, corresponding-medium display data 906, and an inserted state display 907.

The inserted state display 907 indicates whether or not an appropriate removable medium is stored (or held) in the medium storage 803 of the page. Therefore, for example, removable media stored in the medium storages 803 can also be searched by turning pages. Thus, the medium management device 800 can be used in various manners.

Also in the medium management device 800 of FIG. 8, the icons and contents of removable media can be efficiently managed as in the medium management device 501 of FIG. 5. Specifically, the main display 801 can be used to easily identify stored removable media. More specifically, the individual medium displays 802 each display information about a corresponding inserted removable medium. Therefore, by turning pages, the user can see the pages of the removable media, and can determine that the removable media are actually stored in the medium storages 803.

Note that the medium management devices 501 and 800 described above with reference to FIGS. 5 and 8 can also be used to browse the contents of removable media. For example, only favorite images may be selected and displayed, whereby the medium management device may be used in a very conventional album-like manner. In this case, electronic paper is preferably employed as the display screen so that the contents of removable media can be browsed when the medium management device is not turned on.

As described above, the removable medium of the present disclosure has a medium information display, and is useful for data storage applications. Also, the medium management device of the present disclosure is useful for management of a large number of removable media each having a medium information display.

What is claimed is:

1. A removable medium comprising:
a data separator configured to separate data input from an external apparatus into storage data and display data;
a data storage configured to store the storage data as a content; and
a medium information display configured to display the display data as an image, wherein
the medium information display is configured to, even after the removable medium is removed from the external apparatus, continue to display an image as it was displayed immediately before the removal of the removable medium, and
the removable medium further has a function of outputting the display data of the medium information display to the outside.

2. The removable medium of claim 1, wherein
the medium information display includes electronic paper which requires power only when display is updated.

3. The removable medium of claim 1, wherein
the medium information display displays the display data, and image data obtained by converting the display data, together.

4. The removable medium of claim 3, wherein
the converted image data represents a two-dimensional bar code.

5. The removable medium of claim 1, wherein
the medium information display displays a remaining storage capacity of the data storage based on a predetermined remaining capacity display style.

6. The removable medium of claim 5, further comprising:
a remaining capacity display style storage configured to store the remaining capacity display style.

7. The removable medium of claim 1, wherein
the medium information display displays a time of recording of the data storage.

8. The removable medium of claim 1, wherein
the medium information display has a region where information is written during initialization and a region where information is updated every time data is recorded into the removable medium.

9. The removable medium of claim 1, wherein
the removable medium has a function of outputting information about a resolution of the medium information display to the outside.

10. A medium management device comprising:
a medium determiner configured to determine whether or not display data is stored in a removable medium;
a display data reader configured to read the display data when the medium determiner determines that the display data is stored in the removable medium;
a content reader configured to read a content stored in the removable medium; and
a management information display configured to display the content and the display data in association with each other.

11. The medium management device of claim 10, further comprising:
a plurality of individual medium displays each configured to display a content and display data of a corresponding removable medium in association with each other.

12. The medium management device of claim 11, wherein
the plurality of individual medium displays each have a state display configured to display whether or not the corresponding removable medium is currently connected to the medium management device.

13. The medium management device of claim 11, wherein
the plurality of individual medium displays each have an interface configured to allow connection to the corresponding removable medium.

14. The medium management device of claim 11, further comprising:
a main display configured to display a content of one selected from removable media corresponding to the plurality of individual medium displays, and display data of the selected removable medium, in association with each other.

15. The medium management device of claim 14, wherein
the main display further displays information indicating whether or not the selected removable medium is currently connected to the medium management device.
